(19) United States
(12) Patent Application Publication
(10) Pub. No.: US 2007/0128460 A1
(43) Pub. Date: Jun. 7, 2007

(54) Paper coating composition

(76) Inventors: Gerald D. Miller, Humble, TX (US); Jorgen Forsbacka, Perstorp (SE); Arne Jens-Mikael Gottberg, Kristianstad (SE)

Correspondence Address: M. Susan SPIERING;c/o Celanese Ltd., IP Legal Dept, IZIP 701, P.O. Box 428, Bishop, TX, 78343, US

(21) Appl. No.: 11/295,904

(22) Filed: Dec. 7, 2005

(51) Int. Cl. B32B 27/00; C08L 29/04

(52) U.S. Cl. 428/500; 524/445; 524/425; 524/503

(57) ABSTRACT

Coating compositions, methods of applying the coating compositions, and articles incorporating the coating compositions are provided. The coating compositions are useful for coating a variety of substrates to improve the appearance and printability of the substrates. The coating compositions incorporate pigment system, a binder, and an optical brightener. The binder incorporates a polyvinyl alcohol polymer. The coating compositions exhibit whitening and reversion characteristics superior to coating compositions incorporating conventional components while providing cost advantages over conventional coatings.

### FIELD OF THE DISCLOSURE

This disclosure relates to paper coating compositions and methods of making and using such compositions. The coating compositions incorporate a binder system and amounts of polyvinyl alcohol.

### BACKGROUND INFORMATION

Paper coating compositions, or coating colors, are used by the paper industry to impart the desired moisture resistance, physical properties and appearance to certain grades of finished paper. Generally, the coating composition is an aqueous dispersion consisting mainly of mineral pigments like clay, calcium carbonate or titanium dioxide, and pigment binders of natural protein, starch or synthetic polymer emulsions. Styrene-butadienes and polyvinyl acetates are examples of such synthetic emulsion binders. Coating compositions may also contain additives, such as thickeners, humectants and lubricants.

The coating is generally applied to a paper substrate to improve the appearance of the substrate. An important purpose of a coating is to provide a smooth substrate surface that is substantially free of indentations or valleys. A smooth surface is necessary for printing good quality images on substrates and for effective transfer of ink, or other coloring agent, to the substrate. A smooth substrate surface is obtained by coating the substrate surface with a pigment coating composition.

The coating composition is effectively an aqueous dispersion including mainly mineral pigments such as clay, calcium carbonate, or titanium oxide, and pigment binders of natural protein, for example, casein or soy protein, starch, or synthetic polymers such as emulsions and polyvinyl alcohol. Coating compositions are usually applied to a continuous web of the substrate material by high speed coating machines, such as blade coaters, air knife coaters, rod coaters and roll coaters. The flow properties of coating color compositions for substrates are of significant importance with regard to the runability (or flow) of the color during the coating operation. These flow properties are often controlled by a thickener. It is sometimes advantageous to use faster coaters to increase productivity and to use higher solids coating compositions to decrease drying costs and improve binder distribution.

The coating compositions may often also include additional components such optical brighteners (OBs), defoamers, crosslinkers, etc. High brightness coated grades of paper typically include the optical brighteners. Optical brighteners generally operate by way of absorbing ultra-violet radiation and then immediately re-admitting in the visible blue-white range. Examples of optical brighteners include UVITEX® and TINOPAL® from Ciba Specialty Chemicals, and BLANKOPHOR® from Lanxess. Other optical brighteners include HOSTALUX® and LEUCOPHOR® from Clariant. Most OBs have active ingredients that belong to the stilbene class of compounds.

U.S. Pat. No. 5,057,570 to Air Products and Chemicals, Oct. 15, 1991, describes a process for producing paper coating compositions using partially hydrolyzed, low molecular weight polyvinyl alcohol. The advantage of using this polymer is that no external heating is required and that it can be added as a dry solid to the aqueous pigment dispersion. This can be accomplished under high shear stirring, typically at speeds of 1500 rpm for 15 minutes at room temperature.

U.S. Pat. No. 5,830,241 to Ciba Specialty Chemicals, Nov. 3, 1998, describes a liquid preparation of a fluorescent whitening agent, low molecular weight polyethylene glycol, water and auxiliary compounds. The polyethylene glycol is in liquid form and functions as the non-volatile solvent to stabilize liquid preparations of the agent when stored at elevated temperatures (50° C.). The low molecular weight of the polyethylene glycol has a low viscosity, which results in a pumpable solution.

U.S. Pat. No. 6,521,701 to Coatex S. A. S., Feb. 18, 2003, describes a stable aqueous liquid polymer composition containing polyvinyl alcohol in combination with a homopolymer or copolymer of carboxylic acid in completely acid form. This combination of polymers has been found to optimize the function of water retention, which activates optical brighteners, and which controls the viscosity of coating colors. This is all accomplished without degrading the water-retention property.

U.S. Pat. No. 6,620,294 to Ciba Specialty Chemicals, Sep. 16, 2003, describes stable aqueous solutions of fluorescent whitening agents that contain polyvinyl alcohol. The solutions can be prepared by mixing a moist press filter cake or dry powder of a fluorescent whitening agent with an aqueous solution of a modified or unmodified polyvinyl alcohol, with or without optional additives, and heating and mixing until a homogeneous distribution is obtained.

While OBs alone work well, the inclusion of PVOH boosts their performance. In some cases, paper makers use standard PVOH grades purchased in dry form that are then prepared for use by cooking in conventional batch vessels. A disadvantage of this methodology is that the water used in the PVOH cook dilutes the coating formulation by a significant amount, which can negatively impact production rates. In addition, there is a cost to the mill for cooking PVOH; and, in many cases, that cost is compounded with problems because of inadequate equipment or poorly trained operators. Generally, PVOH is supplied to papermakers in a variety of forms: 1) dry resin that is cooked in water by the customer at 20% to 30% solids, the advantage being that less costly grades of PVOH can be used, the drawbacks being noted above; 2) PVOH that has been pre-cooked and delivered to the customer at 15% to 25% solids, which is costly to the papermaker as it involves shipping mostly water; and 3) dry, fine particle size partially hydrolyzed grades that are added dry to the pigmented formulations. These latter products are relatively expensive ground material, but are convenient if cooking is not an option. See U.S. Pat. No. 5,057,570. See also U.S. Pat. No. 6,620,294 where there are described solutions of PVOH and optical brighteners prepared by thoroughly mixing the moist press cake or the dry powder of a fluorescent whitening agent with an aqueous solution of PVOH and heating.

### BRIEF DESCRIPTION OF THE DISCLOSURE

This disclosure relates to coating compositions, methods of applying the coating compositions, and articles of commerce incorporating the coating compositions. The coating compositions described herein are useful for coating a variety of substrates such as paper in particular to improve the appearance and printability of the substrates. The coating compositions incorporate a pigment system that may be selected from a variety of suitable systems, including clay and calcium carbonate, and a binder. The binder may be mixed with polyvinyl alcohol, may include polyvinyl alcohol, and optionally the binder may be entirely comprised of polyvinyl alcohol. Generally speaking, the polyvinyl alcohol is operative to: (i) reduce lightness decay of the coating composition upon UV aging of the coating composition as compared with a like composition prepared with less polyvinyl alcohol; (ii) reduce UV brightness decay of the coating composition upon UV aging as compared with a like composition prepared with less polyvinyl alcohol; and (iii) suppress yellowness increase of the coating composition upon UV aging of the coating composition as compared with a like composition prepared with less polyvinyl alcohol. A like composition with less polyvinyl alcohol refers to a substantially identical composition where at least some polyvinyl alcohol has been replaced with a binder resin and the coating composition has less than 1 part by weight polyvinyl alcohol per 100 parts by weight pigment. For example, a coating composition with 2.5 parts polyvinyl alcohol per 100 parts pigment and 7.5 parts SBR (styrene-butadiene rubber) latex per 100 parts pigment is compared with a like composition outside of the scope of the present invention having 9.5 parts SBR per 100 parts pigment and 0.5 parts polyvinyl alcohol per 100 parts pigment; the two compositions being otherwise identical.

In one embodiment the composition comprises, a pigment, a binder that comprises about 7% by weight to about 100% by weight of polyvinyl alcohol, and an optical brightener.

The use of the binder disclosed herein increases the brightness of the article on which the coating composition is applied. The novel binder composition also reduces the amount of brightness reversion that occurs over time. In addition to the beneficial performance characteristics provided by the binder composition, use of the binder has enhanced cost benefits, as compared to conventional binder compositions.

The coating compositions may also include a variety of additional components such as lubricants, defoamers, and other conventional additives.

Among the uses for the coating compositions are coating print media substrates to provide a smooth printable surface on the substrate.

### DETAILED DESCRIPTION OF THE INVENTION

This disclosure relates to coating compositions and methods of applying and using substrate coating compositions. The coating compositions incorporate a unique binder that exhibits beneficial characteristics in comparison to coating compositions incorporating conventional binders. The compositions are generally aqueous based incorporating dissolved or suspended solids that include a pigment, a binder, and an optical brightener. Optionally, the present composition may also include a lubricant for enhancing its flowability.

The composition may optionally include auxiliaries such as dispersing agents, protective colloids, solvents for the colloids, sequestering agents and the like, none of which change the basic and novel characteristics of the concentrates. When referring to the optical brightener/PVOH aqueous concentrate, auxiliaries also include minor amounts of binder, plasticizer, filler, water retention aids such as carboxymethyl cellulose and so forth.

The pigment may be selected from any pigment useful for substrate coating compositions. Exemplary suitable pigments are aqueous dispersions of coating grade clays, such as kaolin clays, titanium dioxide, calcium carbonate, barium sulfate, talc, zinc sulfate, aluminum sulfate, calcium oxide reaction products, lithopone, zinc sulfide, other coating pigments, other similar materials, and mixtures thereof. In one embodiment, the pigment system comprises at least 90% by weight of clay. In another embodiment, the pigment system comprises at least 90% by weight of calcium carbonate. Additionally, the composition may also contain other additives, such as zinc oxide and/or a small amount of a dispersing or stabilizing agent, such as tetra-sodium pyrophosphate.

Ingredient units are expressed as dry pts/100 pigment, except for the OB, which is usually expressed as wet parts/100 pigment. In terms of raw materials, pigments are delivered in dry or in water pre-dispersed form that may range from about 70% to 76% solids. Parts refers to parts by weight unless otherwise stated.

The binder may be selected from any suitable binder useful for binding the pigment particles and other solids in the coating composition. Exemplary binders are natural protein materials such as casein or soy protein, starch, or synthetic polymer emulsions such as a latex material incorporating a styrene butadiene, acrylic latex, vinyl acetate latex, or styrene acrylic copolymers, or natural occurring latex materials, a polyvinyl alcohol polymer material. Latexes are typically delivered at about 50% solids.

As noted above, optical brighteners that may possibly be used with the composition described herein includes concentrates having the tradenames UVITEX® and TINOPAL® from Ciba Specialty Chemicals, BLANKOPHOR® from Lanxess, other optical brighteners include HOSTALUX® and LEUCOPHOR® from Clariant. In one embodiment, the composition may include up to 1 part of optical brightener for every 100 parts of pigment. The optical brightener concentrate may further comprise polyethylene glycol in some cases and the optical brightener active ingredient comprises a stilbene compound. The stilbene compound may be a sulfonated stilbene compound may be a stilbene compound as noted above. OBs for coating may be delivered in liquid form at about 17% active ingredient, and can be of the tetra or hexa sulfonated variety.

Suitable lubricants for use with the present composition can include calcium stearate, polyethylene emulsions, and polyglyceride. In one embodiment, the composition may include up to 1 part of lubricant for every 100 parts of pigment.

In one embodiment, the paper coating composition may comprise from about 75 parts to about 125 parts of pigment and from about 4 to about 15 parts of binder. In another embodiment, the paper coating composition may comprise from about 80 parts to about 110 parts of pigment and from about 5 parts to about 13 parts of binder. In yet another embodiment, the paper coating composition may comprise from about 80 parts to about 105 parts of pigment and from about 5.5 parts to about 12 parts of binder. In yet one additional embodiment, the paper coating composition may comprise substantially 100 parts of pigment and from about 6 parts to about 11 parts of binder.

In a preferred aspect of the invention the collective amount of polyvinyl alcohol and other binder is from about 5 parts per 100 parts pigment binder to about 15 parts per 100 parts pigment. Typically, a collective amount of other binder and polyvinyl alcohol is from about 2 parts per 100 parts pigment to about 10-parts per 100 parts pigment; suitably from 4 to 8 parts per 100 parts pigment binder. In one especially preferred embodiment, other binder is absent and polyvinyl alcohol resin is the only binder present.

In one embodiment, when the binder for use with the composition comprises latex (such as styrene butadiene or a polyvinyl acetate emulsion), it may comprise up to about 15 parts for every 100 parts of pigment. Optionally, the latex binder may comprise up to about 12 parts for every 100 parts of pigment. Alternatively, the latex binder may comprise up to about 10 parts for every 100 parts of pigment. Yet still optionally, the latex binder may comprise up to about 8 parts for every 100 parts of pigment. In another embodiment, the latex binder may comprise up to about 6 parts for every 100 parts of pigment.

PVOH can be included in the composition in an amount for every 100 parts of pigment; this amount may be any range workable for achieving a coating having desired qualities of whiteness, brightness, and decreased reversion. PVOH can typically be prepared from polyvinyl acetate resins by saponification thereof which is well known in the art. PVOH resins are derived from homopolymers of vinyl acetate as well as copolymers of vinyl acetate with other ethylenically unsaturated monomers and may include cationic sites if so desired. Typically, the polyvinyl alcohol resin has a viscosity of from 3 cps to 4 cps and the aqueous concentrate is from about 25 to about 65 percent solids. Preferably, the resins are 95 mole percent or more vinyl acetate derived. Suitable resins, available from Celanese, Inc. include:

TABLE 1
Polyvinyl Alcohol Resins

| Grade | % Hydrolysis, | Viscosity, cps¹ | pH |
|---|---|---|---|
| Celvol 125 | 99.3+ | 28-32 | 5.5-7.5 |
| Celvol 165 | 99.3+ | 62-72 | 5.5-7.5 |

Fully Hydrolyzed

| | | | |
|---|---|---|---|
| Celvol 103 | 98.0-98.8 | 3.5-4.5 | 5.0-7.0 |
| Celvol 305 | 98.0-98.8 | 4.5-5.5 | 5.0-7.0 |
| Celvol 107 | 98.0-98.8 | 5.5-6.6 | 5.0-7.0 |
| Celvol 310 | 98.0-98.8 | 9.0-11.0 | 5.0-7.0 |
| Celvol 325 | 98.0-98.8 | 23.0-32.0 | 5.0-7.0 |
| Celvol 350 | 98.0-98.8 | 62-72 | 5.0-7.0 |

Intermediate Hydrolyzed

| | | | |
|---|---|---|---|
| Celvol 418 | 91.0-93.0 | 14.5-19.5 | 4.5-7.0 |
| Celvol 425 | 95.5-96.5 | 27-31 | 4.5-6.5 |

Partially Hydrolyzed

| | | | |
|---|---|---|---|
| Celvol 502 | 87.0-89.0 | 3.0-3.7 | 4.5-6.5 |
| Celvol 203 | 87.0-89.0 | 3.5-4.5 | 4.5-6.5 |
| Celvol 205 | 87.0-89.0 | 5.2-6.2 | 4.5-6.5 |
| Celvol 513 | 86.0-89.0 | 13-15 | 4.5-6.5 |
| Celvol 523 | 87.0-89.0 | 23-27 | 4.0-6.0 |
| Celvol 540 | 87.0-89.0 | 45-55 | 4.0-6.0 |

¹4% aqueous solution, 20° C.

PVOH may be delivered in solid form to be cooked into solution prior to using, or in liquid form at 15% to 30% solids.

In one embodiment, for every 100 parts of pigment, the PVOH content of the composition may have lower limits of greater than 1, at least 1.75, at least 2.5, at least 4, and at least 6. The upper limits of the PVOH content include at least 10, at least 15, at least 20, and at least 25. It should be pointed out that PVOH ranges for the compositional mixtures can include combinations of any of the lower ranges with any of the upper ranges of PVOH.

In another embodiment, the binder comprises from about 1.5 parts to about 20 parts of PVOH for every 100 parts of pigment. In even another embodiment, the binder comprises from about 2 parts to about 15 parts of PVOH for every 100 parts of pigment. In still another embodiment, the binder comprises from about 3 parts to about 10 parts of PVOH for every 100 parts of pigment. In yet one additional embodiment, the binder comprises from about 3.5 parts to about 7 parts of PVOH for every 100 parts of pigment. Suitably, the weight ratio of polyvinyl alcohol to other binder resin is greater than 1:4; in some cases greater than 1:2; and in still other cases greater than 1:1.

In one embodiment, the binder comprises from about 7% by weight to about 100% by weight of PVOH. In another embodiment, the binder comprises from about 10% by weight to about 100% by weight of PVOH. In yet another embodiment, the binder comprises from about 26% by weight to about 100% by weight of PVOH. In yet still another embodiment, the binder comprises from about 50% by weight to about 100% by weight of PVOH. It should be pointed out with regard to the composition of the present disclosure that PVOH may comprise a portion of or all of a binder, can be a binder replacement, or can be considered a binder additive. PVOH can also serve to enhance the optical brightener as well as aid in the water retention of the coating composition.

In one embodiment, the polyvinyl alcohol polymers useful in accordance with the compositions, products, and methods described herein have the following characteristics: a degree of polymerization of about 300 to about 4,000, a weight average molecular weight of about 10,000 to about 200,000, and is from about 85 mole % to about 99.9 mole % hydrolyzed. Suitable resins may be partially hydrolyzed (85-90 mole %) or fully hydrolyzed (97-99.9 mole %.

It should be pointed out that scope of the present disclosure is not limited to applying the composition to paper only, but includes the application of the composition herein described to any substrate comprising a print media (i.e. a surface on which something is printed). Examples of suitable substrates include paper, bright white inkjet paper (bond), translucent bond, paperboard, natural tracing paper, vellum, clear film, matte film, coated paper, heavyweight coated paper, high-gloss photo paper, semi-gloss photo paper, paper-based semi-gloss, satin poster paper, studio canvas, banners with TYVEK®, colorfast adhesive vinyl; scanner: non-abrasive paper, vellum, mylar, sepia, blueprints, plastic film, plastic laminate, foam board, and cardboard, to name but a few.

Experimental Evaluations:

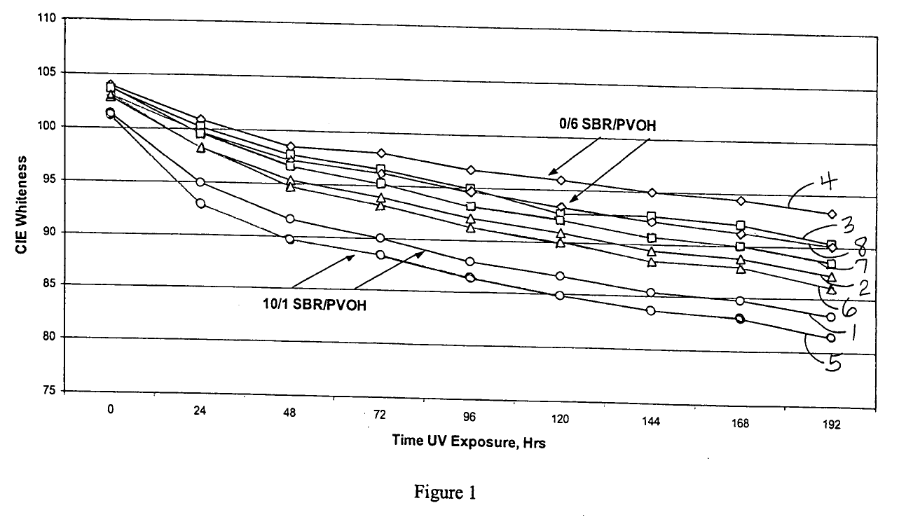

Compositions were prepared with the components of Table 2 and applied to a paper substrate. Eight different compositions were prepared, wherein four of the compositions used one grade of PVOH (partially hydrolyzed) and the other four used a different grade of PVOH (fully hydrolyzed). Components 1-4 have the fully hydrolyzed PVOH (C-103) and components 5-8 having the partially hydrolyzed PVOH (C-203). Tests were conducted on the paper substrates having the different coating compositions, where results are shown in FIGS. 1-3. The tests comprised subjecting the coated papers to ultraviolet light for a period of time. The brightness reversion, blue-light values, and whiteness were measured and recorded at 24-hour intervals for a period of time up to 192 hours.

TABLE 2

| Component | 1 | 2 | 3 | 4 | 5 | 6 | 7 | 8 |
|---|---|---|---|---|---|---|---|---|
| calcium | 80 | 80 | 80 | 80 | 80 | 80 | 80 | 80 |
| carbonate | | | | | | | | |
| Particle clay | 20 | 20 | 20 | 20 | 20 | 20 | 20 | 20 |
| Latex binder | 10 | 7 | 4 | 0 | 10 | 7 | 4 | 0 |
| PVOH (C103 | 1 | 2.5 | 4 | 6 | 1 | 2.5 | 4 | 6 |
| or C203) | | | | | | | | |
| Ca-stearate | 0.4 | 0.4 | 0.4 | 0.4 | 0.4 | 0.4 | 0.4 | 0.4 |
| Leucopher LCP | 0.75 | 0.75 | 0.75 | 0.75 | 0.75 | 0.75 | 0.75 | 0.75 |
| Total Binder | 11 | 9.5 | 8 | 6 | 11 | 9.5 | 8 | 6 |
| Amount | | | | | | | | |
| Solids content | 68.4 | 68.4 | 68.4 | 68.4 | 68.4 | 68.4 | 68.4 | 68.4 |
| % | | | | | | | | |

Suitably, CIE L*, a*, b* and brightness values are used to characterize coated products prepared with coating formulations of the invention. L*, a*, and b* values may be suitably measured using test methods such as TAPPI T 524 om-02, TAPPI T 527 om-02, or similar methods. TAPPI T 524 incorporates 45° directional illumination and perpendicular (0°) observation geometry. TAPPI T 527 incorporates diffuse illumination and 00 observation geometry. L* is a measure of lightness increasing from 0 for black to 100 for perfect white; a* indicates redness when positive and green when negative; b* indicates yellowness when positive and blueness when negative. Note that (GE) brightness is measured in accordance with TAPPI T 452 om-02. TAPPI 452 incorporates 45° illumination and 0° observation geometry. Unless otherwise indicated, Brightness values are reported with ultra-violet (UV) radiation. To calculate Brightness without UV, the UV component is subtracted from the UV Brightness.

FIG. 1 is a graphical representation of the CIE whiteness measurements of paper specimens coated with the compositions of Table 2. The eight lines represent testing performed on the eight different compositions of Table 2. For example, the uppermost line The graph illustrates the whiteness at T=0 and how the whiteness decreases over time. From FIG. 1 it is clear that compositions having an increasing percentage of PVOH exhibit unexpectedly greater values of whiteness. These unexpected increased whiteness values are also realized over time thereby illustrating an unexpected improved rate of whiteness reversion. Moreover, the compositions having the fully hydrolyzed PVOH (C-103) exhibit unexpected improved whiteness (initially and over time) over that of the composition having the partially hydrolyzed PVOH.

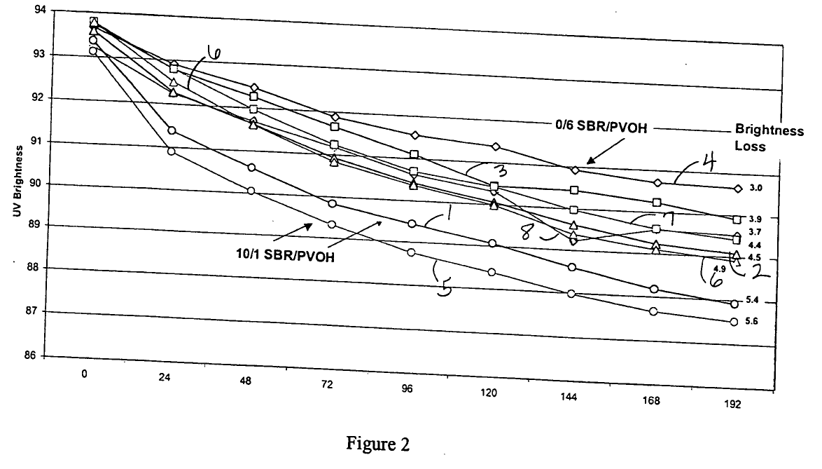

FIG. 2 graphically illustrates the UV brightness over time of the compositions of Table 2. Each plot of FIG. 2 includes a reference number corresponding to the associated composition number. As with the whiteness values, the brightness values of compositions having greater amounts of PVOH are unexpectedly improved over those having lower PVOH amounts. Also as with FIG. 1, FIG. 2 demonstrates how unexpectedly enhanced brightness values can be achieved by using a binder with a fully hydrolyzed PVOH over a partially hydrolyzed PVOH.

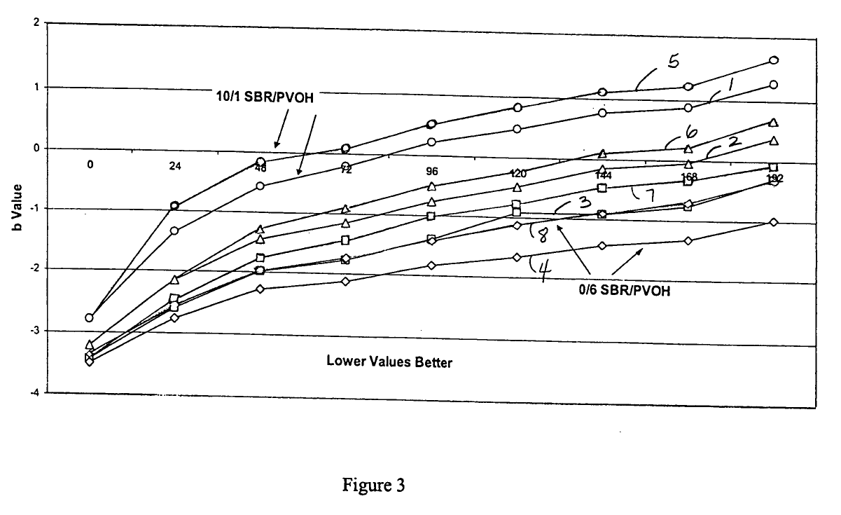

FIG. 3 portrays Blue-White b values of the coated papers having the compositions of Table 2. Here also unexpected improved results are realized with increasing amounts of PVOH in the binder as well as using fully hydrolyzed PVOH.

All patents and publications referred to herein are hereby incorporated by reference in their entireties.

Although the present invention and its advantages have been described in detail, it should be understood that various changes, substitutions, and alterations could be made without departing from the spirit and scope of the invention as defined by the following Claims.

What is claimed is:

1. A coating composition comprising:
a pigment;
a binder, polyvinyl alcohol; and
an optical brightener, wherein the polyvinyl alcohol comprises greater than 1 part per every 100 parts of pigment and wherein further the polyvinyl alcohol is operative to:
(i) reduce lightness decay of the coating composition upon UV aging of the coating composition as compared with a like composition prepared with less polyvinyl alcohol;
(ii) reduce UV brightness decay of the coating composition upon UV aging as compared with a like composition prepared with less polyvinyl alcohol; and,
(iii) suppress yellowness increase of the coating composition upon UV aging of the coating composition as compared with a like composition prepared with less polyvinyl alcohol.

2. The composition of claim 1, wherein the polyvinyl alcohol comprises at least 2.5 parts for every 100 parts of pigment.

3. The composition of claim 1, wherein the polyvinyl alcohol comprises at least 4 parts for every 100 parts of pigment.

4. The composition of claim 1, wherein the polyvinyl alcohol comprises at least 6 parts for every 100 parts of pigment.

5. The composition of claim 1, wherein the polyvinyl alcohol comprises from about 15% up to about 100% of the combined weight of the polyvinyl alcohol and the binder.

6. The composition of claim 1, wherein the polyvinyl alcohol comprises from about 50% up to about 100% of the combined weight of the polyvinyl alcohol and the binder.

7. The composition of claim 1, wherein the polyvinyl alcohol has a degree of hydrolysis of from about 85 mol percent to about 90 mol percent.

8. The composition of claim 1, wherein the polyvinyl alcohol has a degree of hydrolysis of from about 97 mol percent to about 99.9 mol percent.

9. The composition of claim 1, wherein the pigment is selected from the group consisting of aqueous dispersions of coating grade clays, titanium dioxide, calcium carbonate, barium sulfate, talc, zinc sulfate, aluminum sulfate, calcium oxide reaction products, lithopone, zinc sulfide, other coating pigments, other similar materials, and mixtures thereof.

10. The composition of claim 1, wherein the pigment comprises at least 90% by weight of the component selected from the list consisting of clay and calcium carbonate.

11. The composition of claim 1, wherein the binder is selected from the group consisting of casein, soy protein, starch, synthetic polymer emulsions, styrene butadiene, acrylic latex, vinyl acetate latex, styrene acrylic copolymers, and mixtures thereof.

12. The coating composition according to claim 1, applied to a paper substrate.

13. In a coating composition including pigment, an optical brightener, polyvinyl alcohol and optionally a binder resin in addition to polyvinyl alcohol, the improvement comprising at least one part by weight polyvinyl alcohol per 100 parts by weight pigment wherein the polyvinyl alcohol is operative to reduce lightness decay of the coating composition upon UV aging of the coating composition as compared with a like composition prepared with less polyvinyl alcohol.

14. The improvement according to claim 13, wherein the polyvinyl alcohol is operative to reduce UV brightness decay of the coating composition upon UV aging of the coating composition as compared with a like composition prepared with less polyvinyl alcohol.

15. The improvement according to claim 13, wherein the polyvinyl alcohol is operative to suppress yellowness increase of the coating composition upon UV aging as compared with a like composition prepared with less polyvinyl alcohol.

16. The improvement according to claim 13, wherein the coating composition has a binder resin in addition to polyvinyl alcohol and the weight ratio of polyvinyl alcohol to binder resin is greater than 1:10.

17. The improvement according to claim 13, wherein the coating composition has a binder resin in addition to polyvinyl alcohol and the weight ratio of polyvinyl alcohol to binder resin is greater than 1:4.

18. The improvement according to claim 13, wherein the coating composition has a binder resin in addition to polyvinyl alcohol and the weight ratio of polyvinyl alcohol to binder resin is greater than 1:2.

19. The improvement according to claim 13, wherein the coating composition has a binder resin in addition to polyvinyl alcohol and the weight ratio of polyvinyl alcohol to binder resin is greater than 1:1.

20. A coating composition comprising:
pigment;
polyvinyl alcohol;
an optional binder; and
an optical brightener,
wherein polyvinyl alcohol is present in an amount greater than 1 part per 100 parts pigment and the collective amount of polyvinyl alcohol and other binder in the composition is present in an amount of from about 5 parts PVOH and binder per 100 parts pigment to about 15 parts PVOH and binder per 100 parts pigment with the proviso that polyvinyl alcohol is present in amounts operative to:
(i) reduce lightness decay of the coating composition upon UV aging of the coating composition as compared with a like composition prepared with less polyvinyl alcohol;
(ii) reduce UV brightness decay of the coating composition upon UV aging as compared with a like composition prepared with less polyvinyl alcohol; and
(iii) suppress yellowness increase of the coating composition upon UV aging of the coating composition as compared with a like composition prepared with less polyvinyl alcohol.

21. The coating composition according to claim 20, wherein polyvinyl alcohol is present in an amount of from about 2 parts per 100 parts pigment to about 10 parts per 100 weight pigment.

22. The coating composition according to claim 20, wherein polyvinyl alcohol is present in an amount of from about 4 parts per 100 parts pigment to about 8 parts per 100 parts pigment.

23. The coating composition according to claim 20, wherein the optional binder is absent.

24. The coating composition according to claim 23, wherein polyvinyl alcohol is present in an amount of from about 2 parts per 100 parts pigment to about 10 parts per 100 parts pigment.

25. A method of coating a print media substrate comprising:
applying a composition to a surface of the substrate, wherein the composition comprises, a pigment, a binder, polyvinyl alcohol, and an optical brightener, wherein the polyvinyl alcohol comprises greater than 1 part for every 100 parts of pigment.
